(19) United States
(12) Patent Application Publication
(10) Pub. No.: US 2008/0140523 A1
(43) Pub. Date: Jun. 12, 2008

(54) Association of media interaction with complementary data

(75) Inventors: Scott Mahoney, Pacific Palisades, CA (US); Brian Vanyo, Castaic, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(73) Assignee: Sherpa Techologies, LLC

(21) Appl. No.: 11/635,255

(22) Filed: Dec. 6, 2006

(51) Int. Cl. G06Q 30/00; G06F 3/048

(52) U.S. Cl. 705/14; 715/716; 705/27

(57) ABSTRACT

Methods and apparatus, including computer program products, related to association of media with complementary information (e.g., resources). A message characterizing selections of areas of video may be generated and be caused to be sent to a recipient, where the selections were generated by a media player that captures user interaction with the video and displays resources related to the selections in response to the user interaction. Input characterizing an area of a video to be offered for sale may be received and an association of the area of the video with a resource selected by the buyer may be caused to be offered for sale. The area may be designed to be associated with a resource to be displayed in response to user interaction with the area of the video in a media player.

### BACKGROUND

The present disclosure relates to data processing by digital computer, and more particularly to association of media interaction with complementary data.

Media, such as video, may be viewed by users on a computer system, such as a personal computer system, in a media player. If a user of a media player views an item displayed by the media player that is desirable, a user may manipulate the media using media controls, such as controls for pausing and rewinding media, to view details of the item. However, manipulation and interaction with the media is generally limited to altering display of the media. For example, playback of video may be altered by forwarding and rewinding the video. As another example, a video may be resized.

### SUMMARY

The subject matter disclosed herein provides methods and apparatus, including computer program products, that implement techniques related to association of media interaction with complementary data.

A message characterizing selections of areas of video may be generated and the message may be caused to be sent to a recipient. The selections of the areas of video may be received at a media player that captures user interaction with the video and causes actions related to the selections to be performed in response to the user interaction (e.g., actions may include displaying a summary of a product, opening a blog, calling a telephone number, or any combination of actions).

Input characterizing an identification of an area of a video to be offered for sale may be received and an association of the area of the video with a resource selected by the buyer may be caused to be offered for sale. The area may be designed to be associated with a resource to be presented (e.g., displayed) in response to user interaction with the area of the video in a media player. The media player may capture the user interaction with the video and present resources related to the video in response to the user interaction to provide an interactive experience with the video. The resource may be selected from a range of resources associated with the video based on the user interaction (e.g., different resources may be displayed depending on an area that is selected).

Input characterizing a selection of an area of a video may be received at a media player, key words associated with the area of the video may be identified, an advertising engine may perform a search for resources matching search criteria derived from the key words, and results of the search may be provided to a user. The media player may capture user interaction with the video and present a resource related to the selection in response to the user interaction.

The subject matter may be implemented as, for example, computer program products (e.g., as source code or compiled code), computer-implemented methods, and systems. For example, the subject matter may be implemented in cell phones, personal digital assistants, console gaming devices, digital video recorders, and cable television set-top boxes.

Variations may include one or more of the following features.

A recipient may be associated with an address or handle to receive messages. For example, a recipient may be associated with an electronic mailing address (e.g., for domain name system messages or messages in accordance with the Multimedia Internet Mail Enhancements (“MIME”) standard) and the recipient may receive messages at a mail client. As another example, a recipient may have a handle that is associated with an instant messaging service and the recipient may receive messages at an instant messaging client (e.g., AMERICA ONLINE INSTANT MESSENGER). As other examples, recipients may be associated with other information to receive a message. For example, a mobile phone number (e.g., for short message service (“SMS”) or multimedia messaging service messages (“MMS”)).

Actions related to the selections may include opening a media player to display the resources associated with the selections, causing a call to be placed (e.g., by sending an SMS with a phone number to call to a cell phone or starting a voice over internet protocol phone service), causing an electronic mail to be sent, displaying media that is different than the media associated with the selections (e.g., displaying a movie having a same actor that was selected in the selections), causing a song to be played (e.g., a song from an actor that is selected), opening up a web browser with a summary of one or more items in the selections or information related to the selections, displaying ads associated with the selections (e.g., ads from a geographic area associated with an Internet Protocol (“IP”) address of the recipient or the sender of the message), and the like (e.g., any executable program may be called).

Generating a message may include arranging selections in groups of selections. Groups of selections may be hierarchically arranged.

The message may be received by a recipient. For example, at an electronic mailing address associated with the recipient. A media player associated with the recipient (e.g., a media player at the computer used by the recipient) may be caused to display a resource associated with a selection of an area. The resources associated with the selections of areas may include summaries of information about products and links to one or more merchants offering the products for sale. A media player associated with the recipient may be caused to generate bookmarks associated with the selections of the areas (e.g., caused to import bookmarks into a media player).

A message may include a reference to the selected video.

A media player may display the video in a visual display and the media player may include a user interface to receive user interaction above the visual display of the video. The user interaction may characterize the selections of the areas of the video and the user interaction may result in the selections being sent to a server to find the resources associated with the selections. The server may respond with the resources associated with the selections, where the resources are associated with the video and the resources are to be displayed by the media player.

The media player may separate the visual display and the user interface into two layers (e.g., two logical layers not being visibly distinct to a user) such that a video format need not be modified for the media player to generate the selections of the video based on the user interaction, request the resources related to the selections of the video, and to display the resources related to the selections.

Receiving the input may include receiving the input characterizing the identification via a request from a web browser. The listing the area of video as for sale may be part of an auction on a web site.

The area of video to be offered for sale may be identified based on user-clicks on the area of the video and a lack of an association of the area of the video with a resource to be displayed in response to interaction with the area of the video.

Input characterizing a second selection of a second area of the video and the key words may be received. The second area of the video may be associated with the key words. The area of the video may be within the second area of the video.

Second input characterizing the selection of the area of the video may be received. The key words associated with the area of the video may be received at a second time. A second search may be performed in response identifying the key words at a second time. Criteria of the second search may include the key words. Results of the second search may be provided to a user, with the results of the second search differing from the search (e.g., a first search).

Second key words associated with the key words may be received. A second search may be performed in response to the identifying the second key words, where criteria of the second search includes the second key words. Results of the second search may be provided as recommendations to the user. The advertising engine may prioritize results of the search based on a predetermined order of priority for advertisements, if the results include advertisements being prioritized.

The subject matter described herein can be implemented to realize one or more of the following advantages. User interaction with media via a media player may be associated with complementary data that is presented to a user. For example, a resource, such as a summary of information of a product, may be associated with an area of media and the summary may be presented to a user in response to user interaction. Advantageously, the complementary data may be encapsulated (e.g., as a reference to the complementary data or the complementary data may be included in a message) and one or more of the encapsulations may be caused to be transmitted to another user or media player (e.g., for viewing or importing by the other user). The complementary data may be organized in a user interface, for example, as folders. Some of the organization may occur automatically. For example, based on chronology or key words associated with the complementary data. The organization may also be sent to others.

Associations of areas of media with complementary data may be caused to be offered for sale. For example, an auction web site may facilitate the sale of associations of areas of video. Statistics associated with the associations (e.g., a number of clicks of an area) may be logically stored in a central storage such that the statistics may be used to enrich listings of sales of the associations. Areas of video that have clicked by users of a media player but have not been defined as being for sale may be identified. These areas may be found based on the lack of a definition of the area and they may then be defined and offered for sale. Although areas offered for sale may be predefined (e.g., by persons reviewing video and generating areas for association), areas of video that may be sold may be defined by a user. Advantageously, areas of video that might not have been considered worth defining may be sold.

A commentary user interface may be provided for associations of areas of media and complementary data. Advantageously, a commentary user interface may allow for a social networking environment to be created where users may leave feedback on products, such as like or dislikes of a product, information about other products or clicks, and the like. The social network environment may be improved by providing the commentary user interface in concert with other tools for social networking, such as an instant messaging tool. As another example, a blog may be maintained for areas of video to provide a collaborative workspace. For example, when reviewing a video of a presentation, work colleagues may click on areas of the video and add critiques, which may later be viewed, completely, by a blog of the critiques that is automatically generated. In addition, the areas of the video associated with the comments may be viewed from the blog. The complementary data, such as commentary, may be separated from the media such that complementary data need not be transmitted or copied with the media (e.g., by associating the commentary with x, y, and playback time coordinates rather than integrating the data in a video file itself). Advantageously, a content creator of media need not worry about copyright violations, as complementary data need not be transmitted or copied with the media. An area of video may be associated with key words rather than a hard link and those key words may be used to search for complementary data matching the key words. Advantageously, updated information may be facilitated by avoiding a need to update individual associations with areas of video. For example, search results including data from sponsors may differ based on a change of sponsors over time, and the individual links to areas of videos need not change, as the key word associations may change or a database of sponsor content may change. As another example, a price of an item may change daily and that item may be associated with key words, such that the price data associated with key words may change but the association of the key words with the area of video need not change. This may be advantageous where key words are associated across videos. For example, the key words “red sweater” may be chosen for a larger clothing retailer across all videos, and, the individual links for each video need not be changed, rather, a single link to the association with the advertiser may change. As another example, a process of prioritizing search results may differ over time, and such a system may adapt for such a process. For example, a very supportive sponsor may be prioritized for a first thousand results of a day (for certain key words) and the sponsorship prioritization may change after the first thousand results.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is an illustration of a user interface of a tool for viewing complementary data for media.

FIG. 2 is a diagram of a system for generation and distribution of complementary data for media.

FIGS. 3-6 are illustrations of user interfaces to organize data associated with user interaction with media.

FIG. 7 is a diagram of an environment for distribution of references to complementary data for media.

FIGS. 8-9 are illustrations of user interfaces for viewing complementary data about media.

FIG. 10A is a diagram of a system to distribute resources related to media.

FIGS. 10B and 10C are diagrams of systems to facilitate sales of associations of media with data complementary to the media.

FIGS. 11-13 are flowcharts illustrating processes of causing a message characterizing selections of video to be sent, causing a selection of video to be listed for sale, and performing a search based on key words associated with a selection of video, respectively.

Like reference numbers and designations in the various drawings indicate like elements.

### DETAILED DESCRIPTION

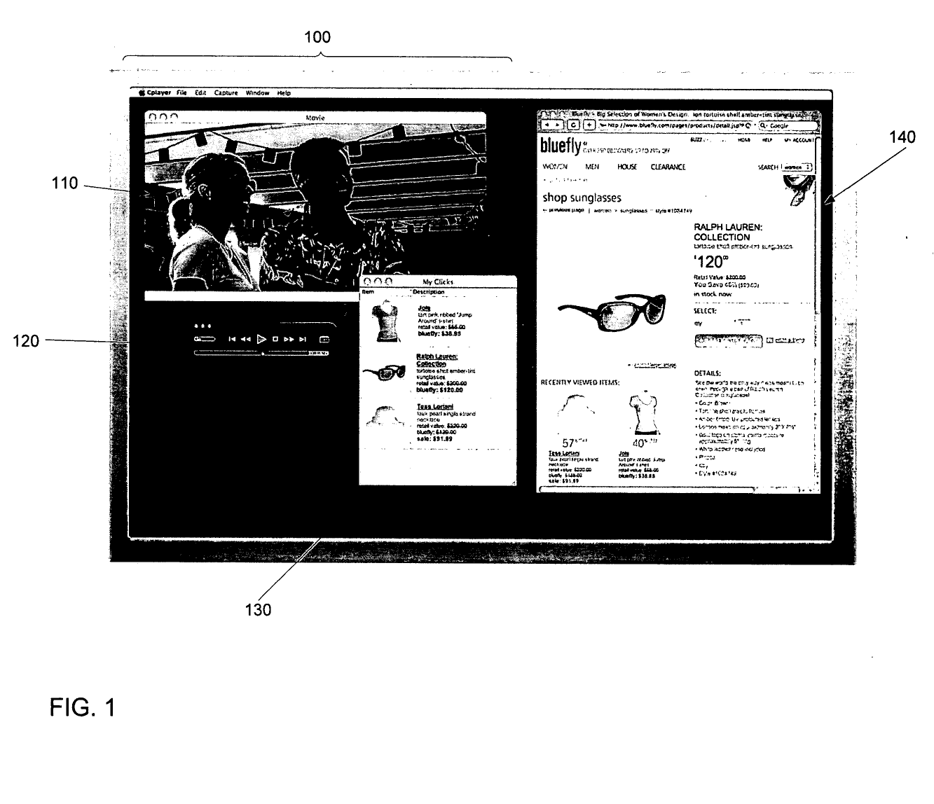

FIG. 1 is an illustration of a user interface 100 of a tool for viewing complementary data for media. The system underlying the user interface may be similar to the systems described in PCT Patent Application entitled “Selective Displaying of Item Information in Videos”, filed Aug. 20, 2004, PCT application number US2004/027250, the contents of which are hereby fully incorporated by reference. For example, the player 1007 of that application may be a media player of the user interface 100 of FIG. 1 of the present application.

In general, the user interface 100 includes a media window 110 that displays media, such as a movie. Display of the media in the media window 110 may be controlled with a media control user interface 120, which may allow for user interaction to drive playing, rewinding, fast-forwarding, and the like of media. The media window 110 may receive data characterizing user interaction with media displayed in the media window 110. For example, a user may click on the media window in a mouse-driven graphical user interface environment and the media window 110 may receive data characterizing the x, y coordinates associated with the area of the media clicked. A media player underlying the user interface 100 may associate those coordinates with other information, such as a playback time for video media displayed in the media window 110.

The user input received by the media window 110 and other information may be used to drive events, such as displaying information or other types of resources related to the media, which may be referred to complementary data. For example, data characterizing x, y coordinates of user interaction may be used with playback time information to retrieve data associated with the region of the media clicked at that time. The data related to the media may be displayed in the click history user interface 130, the internet browser 140, or both. For example, in response to a user clicking on a red sweater displayed in the media window 110, x, y coordinates may be associated with a playback time of the media. That information may be used to search a database of information associated with the media. A result of the search may be a picture of a red sweater and product information for the red sweater, and that information may be displayed in the click history user interface 130 and an internet site offering the sweater for sale may be displayed in the internet browser 140.

In addition to displaying data (e.g., information) about media that has been interacted with in the media window 110, the click history user interface 130 may display an organized history of that information. For example, complementary data for a last five user interactions may be displayed in an order of most-recently-interacted-with in click history user interface 130.

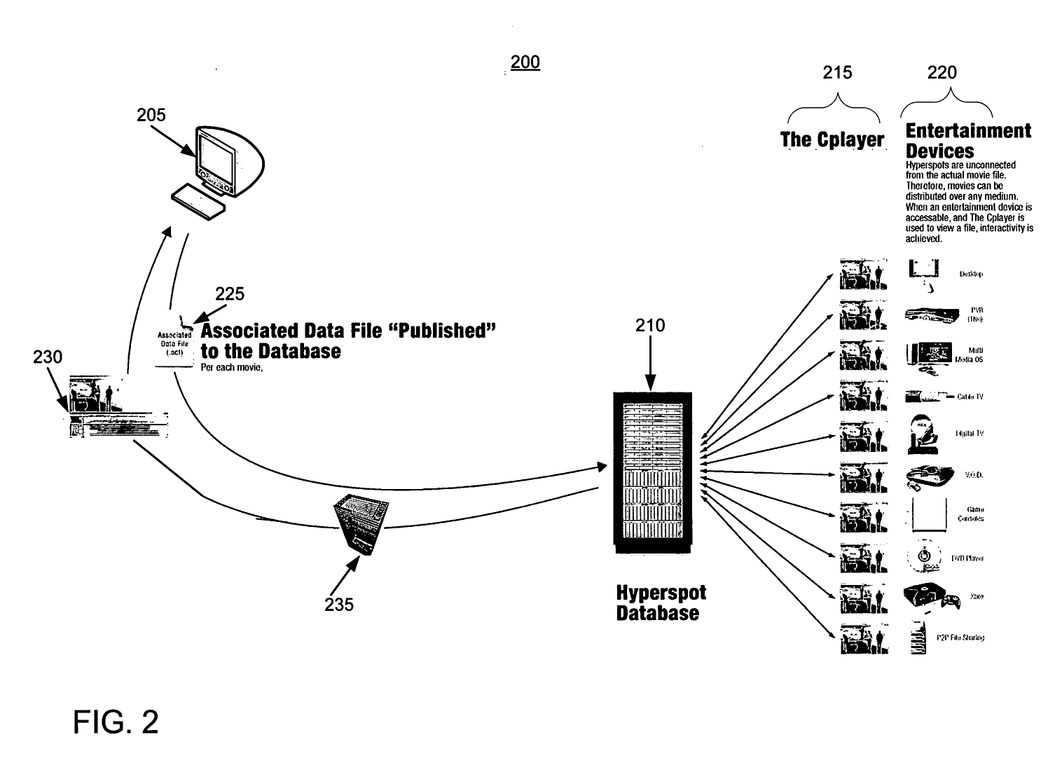

FIG. 2 is a diagram of a system 200 for generation and distribution of complementary data 225 for media. The system 200 of FIG. 2 may be similar to the system 1000 of the above-referenced PCT application. For example, the authoring tool 1016 of that application that generates associated data 1012 may be a tool used by a computer system 205 to generate an associated data file 225.

In general, the system includes the computer system 205 which may be used to generate data that includes information associated with media, which may be in the form of an associated data file 225. For example, a universal resource locator (“URL”) may be associated with a region of x, y coordinates and playback times of a video, and that information may be included in the associated data file 225. The associated data file 225 may be stored in a database 210 which may store information associated with media and data characterizing the associations (e.g., a record may include a unique identifier of a video, an area of a video across time, and a product associated with the area of video). Data characterizing an association of media and complementary data may be referred to as a “hyperspot.”

Once published, the associations may be used by the database 210 to distribute information related to media. The database 210 may distribute this information by responding to requests, from the media players 215, for information associated with media. The requests may come from any of the media players 215 that are implemented for of any of the entertainment devices 220. The requests may be sent in response to media being interacted with in the media players 215. To provide for display of media and information related to the media, and interactivity with the media to display the information related to media, the media players 215 may include user interfaces similar to the user interface 100 of FIG. 1. In some implementations, the information that is included in a response from the database 210 may include information related to an interaction with media; however, the response need not include the same data included in the associations generated by the computer system 205. For example, the database 210 may interpret a request, search for information associated with a user interaction and respond with the information, rather than an association. In some implementations, the media player 215 may interpret associations, which may be sent by the database 210 (e.g., interpret a URL to find a product summary).

Advantageously, communication with the database 210 and the associations stored in the database 210 may be in standardized formats that facilitate cross-platform use of the associations. For example, a messaging format may be used by the media players to send requests to the database 210 that characterize user interaction with media, and the database 210 may respond in the messaging format with a payload including information associated with the user-interacted-area of media, and that information may be in a HyperTextMarkupLanguage format, that may be parsed and displayed by the media players 215 (e.g., the messaging format may be derived from eXtensible Markup Language (“XML”)).

As the database 210 responds to requests from one or more media players 215, the database may store information associated with those requests. For example, demographic information, user interactions associated with requests (e.g., x, y coordinates, playback time, identification of media played), and the like may be stored. The stored information may be used to generate reports 235 which aggregate, analyze, or both, the information. The reports 235 may be viewed in a computer system, such as the computer system 205. An authoring tool 230 may use the reports 235 to display information about the report. For example, a time-based graph of user-interaction (e.g., hyperspots clicked over playback time) may be displayed along with media associated with the user interaction, and a graphical representation of spots clicked on the media (e.g., as an overlay on a display of the media).

In some implementations, an aggregation of user clicks may be analyzed to generate shapes describing the user clicks (e.g., based on a spatial concentration of clicks). For example, if users tend to click on the inside of a pumpkin in a video, a pumpkin-shaped polygon may be generated based on a history of the user clicks. A computer may automatically generate the shapes based on any number or type of algorithms. For example, a concentration of clicks that are no more than ten pixels from another click may be considered to be part of a same selected area, such that those clicks may be used to determine a list of click coordinates to analyze. From that list, outer-most clicks may be used to determine coordinates of a polygon.

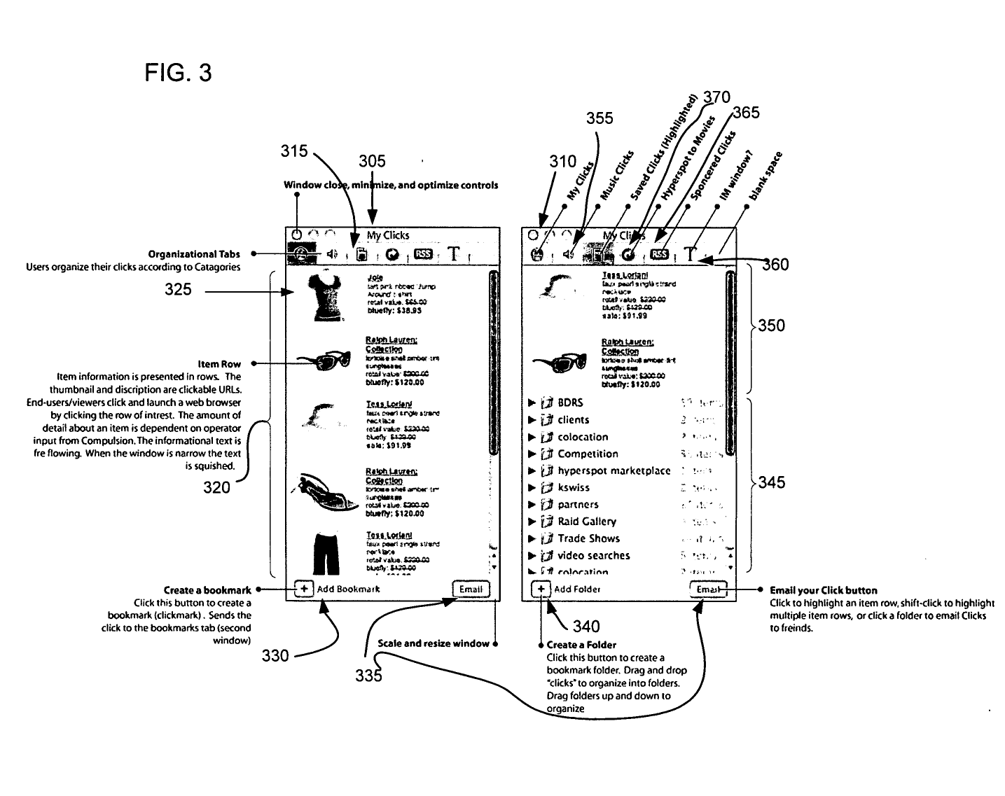

FIGS. 3-6 are illustrations of user interfaces to organize data associated with user interaction with media. The interfaces may be used for a media player, such as the media player discussed above with reference to FIG. 1 or FIG. 2. Data associated with user interaction with media may be referred to as a click. For example, a user may select an area of video in a mouse-driven user interface by clicking on an item displayed in the video. In response to the selection, by a click, data associated with the selected area may be retrieved and displayed in a user interface. The association of the data with the area of video by that type of user interaction may be referred to as a click. However, a click, in the sense of the association of the data retrieved and the area of video, need not occur in response to a click in a mouse-driven graphical user interface environment. For example, a touch-screen device may be used to generate a selection of an area of media that results in data associated with the media being retrieved and displayed to a user.

FIG. 3 includes a click history user interface 305 and a folder organization user interface 310. In general, the click history user interface 305 may be a user interface that stores a history of data associated with user interaction with media. The folder organization user interface 310 may be used to organize data associated with user interaction that has been stored. The folder organization user interface 310 may be based on the click history user interface 305. For example, a user may click on a tab 315 to view stored clicks, and the tab may cause the click history user interface 305 to change to the folder organization user interface 310.

Each of the row items 320 in the click history user interface represents a user interaction that resulted in data associated with the area of media being retrieved. This representation is an encapsulation that characterizes an area of video that may change across time, and may further encapsulate the user interaction that caused the data to be retrieved. For example, the first row item 325 may represent that a user clicked on an area of a video being associated with a t-shirt (e.g., a t-shirt being worn by an actor may be associated with a picture of a t-shirt and a merchant selling the t-shirt). To store references to a click, a user may select a row item to store and click on a user interface control to cause the item to be stored. For example, a user may select the first row item 325, which may become highlighted in response to that selection, and the user may press the “add bookmark” button 330. Stored clicks may be stored local to a media player (e.g., references to clicks may be stored in a file on a client), such as the media player 215 of FIG. 2, or they may be retrieved from a server, such as a server hosting the database 210 of FIG. 2.

The data that is displayed to a user in each of the row items 320 includes a summary of information about a product associated with an area of video. For example, the first row item 325 includes a thumbnail picture of a t-shirt, a short text description, and a price for purchasing the item. The row items 320 may provide for interaction, which may depend on the data in each of the row items 320. For example, the first row item 325 may include a link associated with the price and the link may cause a web browser window to open and display a web site where the item may be purchased. Data that is associated with areas of a video need not be limited to displayable media (e.g., text, pictures, and video). For example, an area of video may be associated with other types of resources, such as audio. Also, the media need not be limited to static content. For example, informational feeds (e.g., Really Simple Syndication (“RSS”) feeds) may be associated with an area of video.

To transmit data associated with media that had been retrieved in response to user interaction with the media, or references to that data, a user may be provided with a user control that causes the data or references to that data to be sent. For example, each of the user interfaces 305, 310 includes an electronic mail button 335 that may be used to cause data characterizing one or more row items to be sent to an electronic mail address. For example, a user may select one or more row items and press the electronic mail button 335 to send an electronic mail message containing a URL characterizing each of the row items. Such a URL may reference, as examples, the resource referenced by the row item (e.g., a link to a web site selling a t-shirt) or information that causes a media player to open with the row item (e.g., a row item with a summary of a t-shirt).

In some implementations, other types of communication instead of, or in addition to, electronic mail may be used to send characterizations of multiple row items. For example, an SMS or MMS containing a list of selected row items may be sent to a mobile phone. As another example, a media player, such as a media player associated with the user interface 305 may include an instant messaging tool and the information may be sent in accordance with an instant messaging protocol for sending messages across media player clients.

The data that is transmitted may include the same or similar organization as the row item(s) in the user interfaces 305, 310. For example, an electronic mail may include headings that mimic the categories of row items of the user interface 310. As another example, a shopping list folder may have sub-folders that are organized by brands, and, the shopping list may be sent to a mobile phone via an SMS. In that SMS, the sub-folders associated with brands in the user interface of the media player may be translated to headings that separate lists of items that are in the sub-folders.

To organize data associated with media, the folder organization user interface 310 includes a folder generation button 340, and displays the data according to folders 345. Data that is not associated with a folder may be stored in an area 350 outside of a folder. The folder generation button 340 may allow a user to generate a folder into which data associated with media may be dragged and dropped. For example, one of row items in an area 350 outside of a folder may be selected, and dragged and dropped into one of the folders 345. By selecting a folder, the row items in the folder may be expanded or collapsed within the folder, such that the folders may be navigated. Any depth of folders may be allowed (e.g., a first folder may have a sub-folder and that sub-folder may have sub-folders), or the number of levels may be restricted.

Data associated with an area of media may be automatically organized according to properties of the data. For example, data that references music files may be organized by a tab 355 that causes only data associated with music files to be displayed (e.g., album names and links to music to purchase or to play). As another example, data that provides links to video may be organized by a tab 370 that causes only links to movies to be displayed.

In some implementations, items may be automatically organized into folders by key words associated with data. For example, a folder name may be used to provide a default mapping of a stored data associated with a selection of an area of media. For example, a folder may be named clothing and all row items having the word clothing or related words, such as t-shirt, pants, and the like, that appear in a description of the item may be used to automatically organize the item as being in the clothing folder when the item is first stored (e.g., when a click is first bookmarked).

To provide for interaction with others, the folder organization user interface 310 may further include a collaboration tool. For example, the folder organization user interface 310 includes an instant messaging tab 360 that may cause an instant messaging tool to be displayed in the user interface 310. For example, in an instant messaging tool, users may discuss clicks they have retrieved and send clicks to each other (e.g., a list of clicks; e.g., such that folder organization of clicks may be imported to another media player).

In addition to displaying data associated with clicks by a user of the folder organization user interface 310, other data may be displayed. For example, an RSS feed button 365 may cause RSS feeds to be displayed, where the RSS feeds provide data associated with sponsors, and that data may include, as an example, summaries of products that display as row items similar to the row items 320 that include product summaries.

As another example, in some implementations, a listing of all items associated with areas of a video may shown (e.g., such that a user need not click on all areas of a video to display all associated data). Such a list may include a picture and short text description for each item that is associated with a video. In that list, a user may click on the items to see a portion of the video associated with the item and the video may include an overlay to highlight or otherwise distinguish the item from other portions of the video. For example, portions of a video may be associated with a shirt and jeans offered by a retailer. For example, an actor's shirt and jeans may be associated with shirts and jeans offered by the retailer (e.g., and the shirt offered by the retailer need not be the same shirt worn by the actor). Summaries of retailer's shirts and jeans may be associated with the respective portions of video showing the actor wearing the shirt and jeans. A list of the summaries may be shown in a window associated with a media player and clicking on one of the summaries may cause the associated portion of video to be shown with the associated area of video circled with a red line.

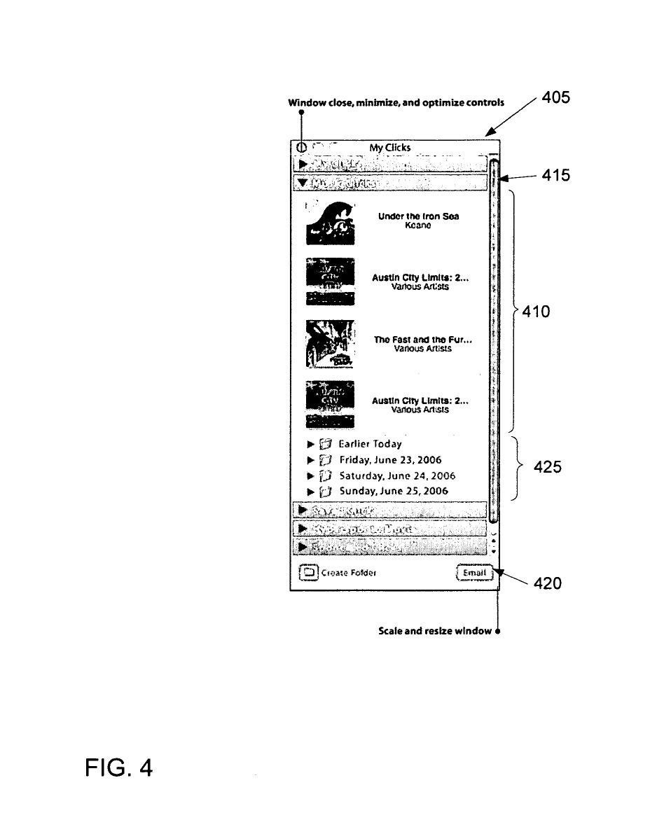

FIG. 4 includes a click organization user interface 405 that organizes folders of clicks by categories and chronological order. The click organization user interface 405 has similarities with the user interfaces FIG. 3. For example, a history of data associated with media is displayed as row items 410. As another example, groups of data associated with media may be organized according to properties of the data (e.g., in folders). For example, data associated with music has a supercategory 415. As another example, a control is provided for sending a characterization of the data associated with media by electronic mail (e.g., e-mail button 420). In contrast to the user interfaces of FIG. 3, a different combination of user interface controls provide a user interface for organizing the data, which may provide a different user experience. Also, as displayed, the organization of the clicks may differ within different levels of organization. For example, data may be organized by media type and further by chronology. For example, data may be grouped as being related to music in the music supercategory 415, and further organized by chronology by date in one of the date folders 425.

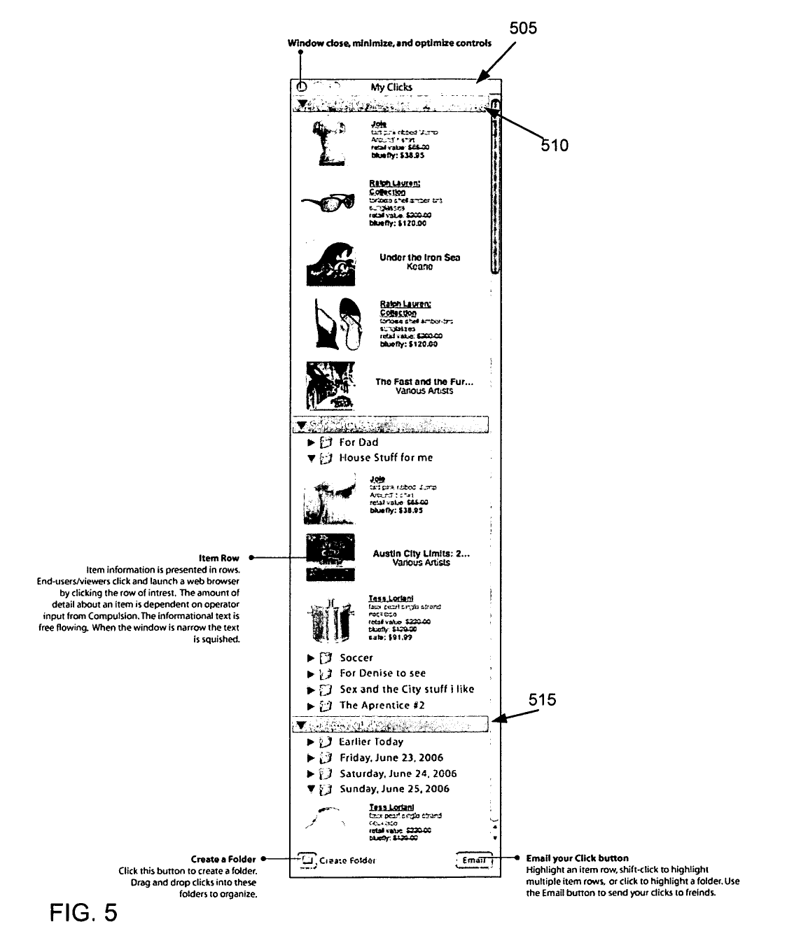

FIG. 5 includes a click organization user interface 505 that is similar to the click organization user interface 405 of FIG. 4. In contrast to the interface of FIG. 5, the click organization user interface 505 of FIG. 5 includes a history supercategory 510 to organize a history of data associated with areas of media that may go beyond the history of data retained in the recent history click supercategory 515. For example, the recent history click supercategory 515 may be limited to storing a given number of recent data retrieved in response to user interaction (e.g., five recent clicks), or the history may be limited on a per-video basis (e.g., each time a new video is viewed, the recent click history 515 is empty), or another or a combination of criteria may used. In contrast to the recent click history 515, the click history supercategory 510 may store more data, which might not be limited, or be limited by other criteria. For example, the recent history click supercategory 515 may be limited to five recent clicks and the click history supercategory 510 may be limited to a five megabyte storage space.

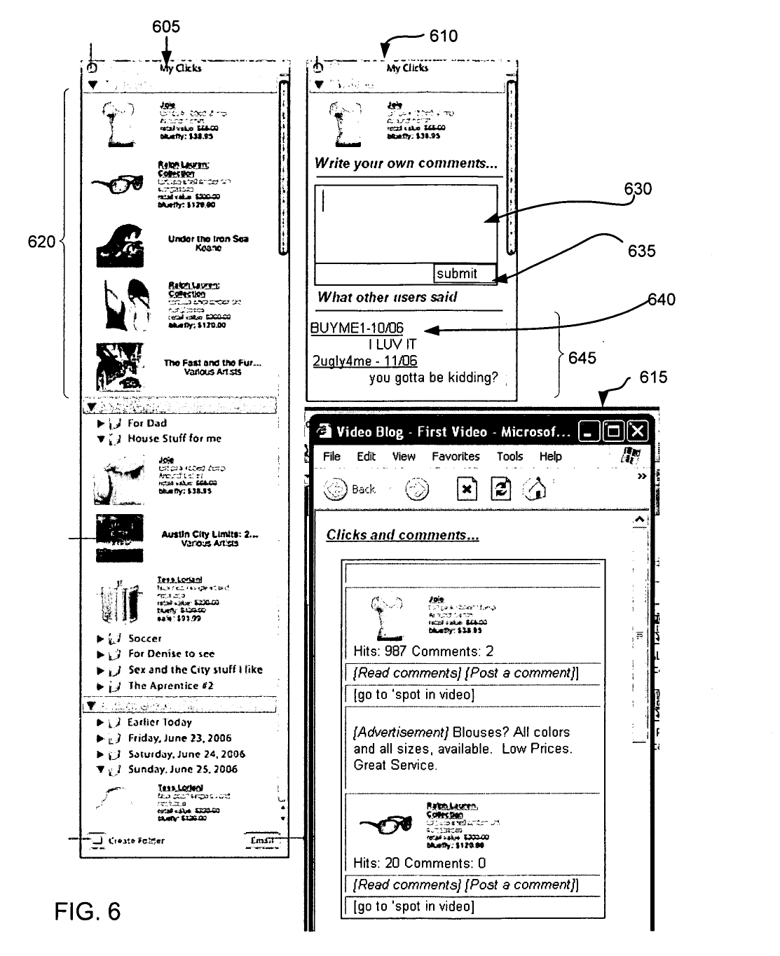

FIG. 6 includes a click organization user interface 605, a commentary user interface 610, and an associated website log 615 (e.g., a blog). The click organization user interface 605 is similar to the click organization user interface 505 of FIG. 5. However, in the click organization user interface 605 of FIG. 6, comments may be viewed and added to data associated with an area of media. The comments may become part of the website log 615. For example, by interacting with one of the row items 620 the commentary user interface 610 may be displayed (e.g., by selecting a row item and using a context menu to select an option for “see blog entry”). The commentary user interface 610 may be part of the click organization user interface 605 or a separate window (e.g., a row item may expand to include a commentary user interface or the commentary user interface 610 may be a separate window). Comments may be obtained from or stored to a database that stores data complementary to media, such as the database 210 of FIG. 2, or the comments may be in a separate database.

The commentary user interface 610 includes a text field 630 for editing comments to be associated with the row item and a list of comments 645. In general, a user may type comments into the text field 630, press a submit button 635 to associate the comments with the data associated with the media, and view the list of comments 645. For example, a user may have submitted a first comment 640 in the list of comments 645 that includes a user name or handle, a date of submission (e.g., 10/06), and a text comment.

Advantageously, the commentary user interface 610 may allow for a social networking environment to be created where users may leave feedback on products, such as like or dislikes of a product, information about other products or clicks, and the like. The social network environment may be improved by providing the commentary user interface in concert with other tools for social networking, such as an instant messaging tool. As another example, a blog may be maintained for areas of video to provide a collaborative workspace. For example, when reviewing a video of a presentation, work colleagues may click on areas of the video and add critiques, which may later be viewed, completely, by a blog of the critiques that is automatically generated. In addition, the areas of the video associated with the comments may be viewed from the blog.

The commentary user interface 610 may enhance a user's experience by providing a tool for leaving and reviewing comments associated with the video that may be comfortably accessible through an interface that is the same as, or related to, a media player. For example, a user need not open a web browser window to view a log of commentary. As another example, as a server to store and fetch comments may use information associating the media area with the data to associate comments, the server may automatically associate new and old comments with a same area of media and a user need not search for descriptions of items to find comments pertaining to an area of media. For example, although a bag may be shown across three minutes of video, and in different areas, a server may easily associate the changing area of video over time with an existing record that already associates the area of video with a description of a merchant offering the bag for sale; thus, a user need not search for comments regarding the bag or merchant.

In variations, the commentary user interface 610 of FIG. 6 may be organized in-line with the click organization user interface 605 as a folder. For example, one of the folders of the click organization user interface 605 may be labeled “click log” or “clog”, and may allow for users to enter comments and the row items of that folder may be separate from other folders. In variations, row items in a comment log may be the row items from other folders. For example, row items that are commented on by a user may be automatically included in such a folder of their media player's user interface. As another example, row items may be chosen by a user to be included in a folder (e.g., through a context menu to select an option for “include in commentary log folder”; e.g., to monitor logs).

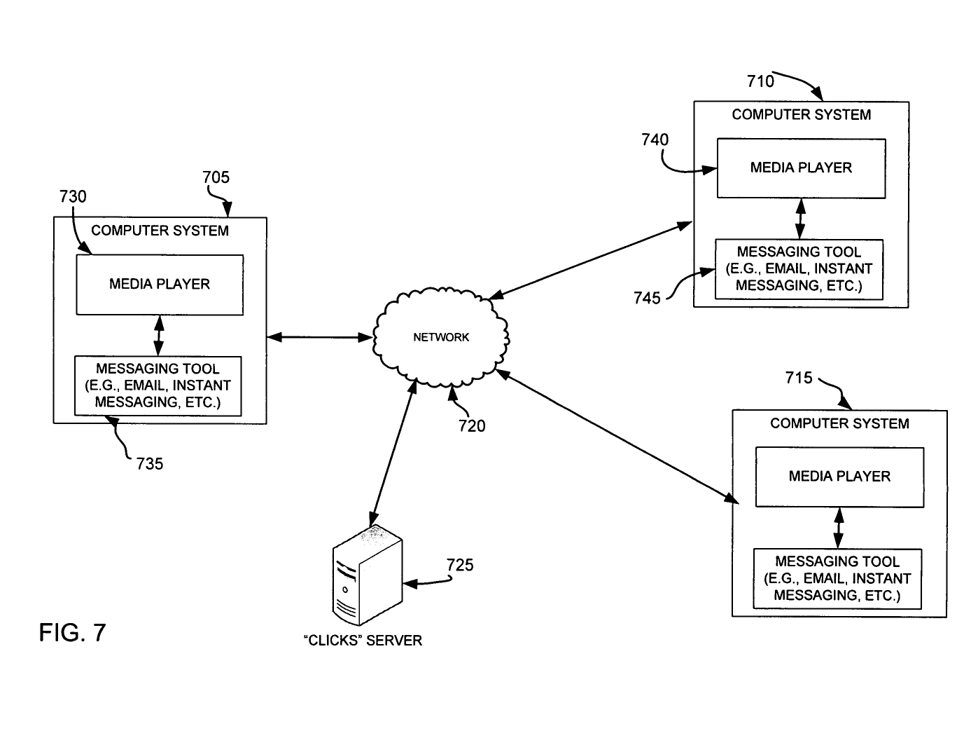

FIG. 7 is a diagram of an environment 700 for distribution of references to complementary data for media. The diagram includes multiple computer systems 705, 710, 715 that may be connected over a network 720 (e.g., the internet) with a click server 725. Each of the computer systems includes a media player and a messaging tool. The media players may differ, as may the messaging tools. The media players may include features similar to the media players discussed above and may have a click organization interface similar to the interfaces described above.

For example, the first computer system 705 includes a media player 730 and a messaging tool 735. The media player 730 may allow for areas of videos to be selected during playback and retrieve data associated with an area of video. The messaging tool 735 may be an electronic mail client from which electronic mail may be sent and received, an instant messaging client from which instant messages may be sent and received, and the like. The media player 730 and the messaging tool 735 may be part of a same application program or they may be separate programs.

The messaging tools may be used to send a message that characterizes data associated with an area of media. For example, a user of the first computer system 705 may select an area of video in the video player 730 and the video player 730 may retrieve data associated with the area of the video. Then, a user may request to send an electronic message to an electronic mail account associated with a user of the second computer system 710 (e.g., by selecting an encapsulation of the data associated with the area, pressing an electronic mail button, and entering an address of a recipient). In response to the request, the message may be generated by the messaging tool and may be caused to be sent. For example, a message may be sent that includes a summary of data associated with an area of media, a link to the summary, an encapsulation of the data received by the video that may be imported into another media player, a link to the video associated with user interaction that caused complementary data to be retrieved, or any combination of data.

In some implementations, data that represents multiple associations of areas of the video and complementary data may be sent. For example, a hierarchy of bookmarks may be sent and viewed or imported by another media player.

The message may be received by the user of the second computer system 710. For example, an electronic mail may be received at a messaging tool 745 of the second computer system 710. A user of the second computer system 710 may view the message and may cause an action to be performed by interacting with the message. For example, the user may click a link which opens a media player 740 that displays an area of video that was selected by the user of the first computer system 705 and a summary of the area of video. For example, a first user may select a bag in a video, a merchant summary of the bag may be displayed to the first user in her media player, and the first user may cause the data representing the area of video to be electronically mailed a second user. Then, the second user may receive an electronic mail including a link, which, when clicked, causes a portion of the video including the bag to be shown with the listing of the bag for sale by the merchant.

Although messages sent among the computer systems 705, 710, and 715 may use their respective messaging tools (e.g., an instant messaging tool), messages that are sent to the server 725 may differ. For example, a different protocol may be used. For example, electronic mails may be sent between the first and second computer systems 705, 710, but a message from the first computer system 705 to the server 725 may be an application to application web services message sent in accordance with a format derived from XML.

The computer systems of FIG. 7 may differ. For example, the first computer 705 may be a personal computer and the second computer 710 may be a set-top box. Also, in variations, the computer may be any device (e.g., mobile phone, console gaming platform, and the like).

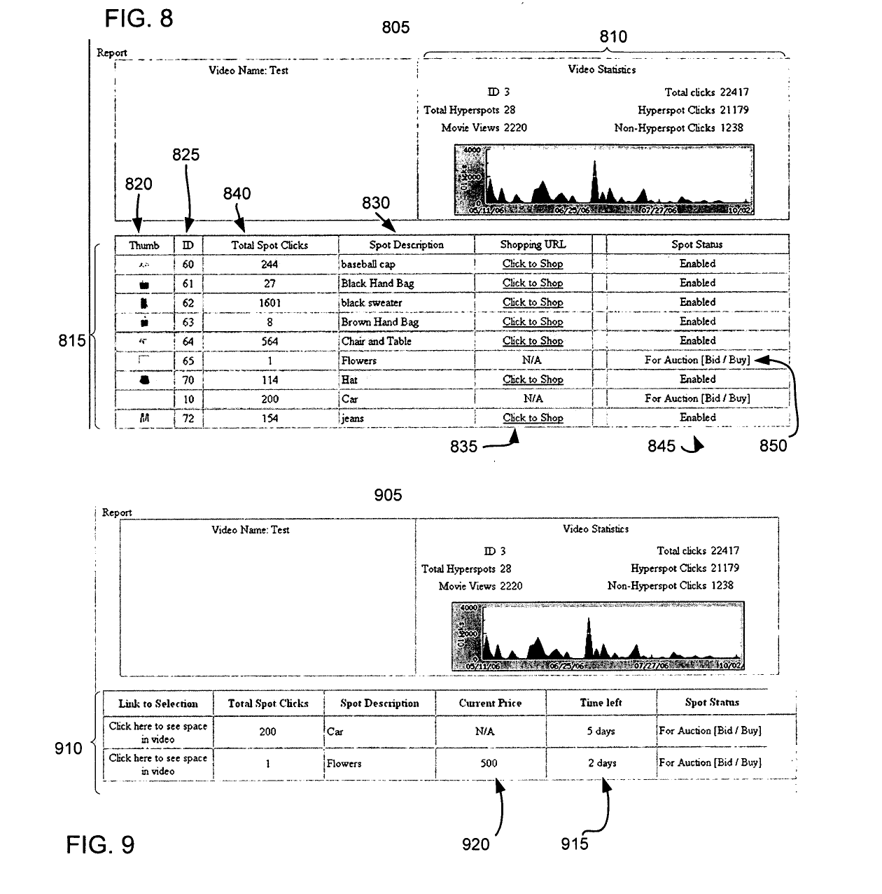

FIGS. 8-9 are illustrations of user interfaces 805, 905 for viewing complementary data about media. The user interfaces may be provided as part of a web site (e.g., they may be web pages) that is used to offer for sale an association of areas of video that may be clicked on by the media players described above. For example, an area of video that represents a bag may be identified and auctioned for sale using the user interfaces 805, 905.

The user interface 805 of FIG. 8 includes statistics 810 for a video and a listing 815 of areas (of space defined over time) defined for a video, which may be referred to as spots or hyperspots. The listing 815 may include data available in a database of area of a video. For example, the listing 815 may include data associated with areas of a video that is stored in the database 210 of FIG. 2. For example, the database may include a thumbnail picture of the area of video, a numerical identifier of the area, a text description, and an associated URL for a merchant offering for sale an item associated with the area of video. That information may be displayed in a thumbnail column 820, an identifier column 825, a description column 830, and a shopping URL column 835. In addition, a statistic 840 for a number of clicks of an area may be displayed, and the data for the statistic may be retrieved from the database and be a result of an aggregation of a request log maintained by the database.

The listing 815 includes a column 845 indicating whether an association of an area of video is for sale or enabled (e.g., currently not for sale). For example, the column 845 indicates that an association of an area described as “flowers” is up for auction (e.g., is available for bidding) and is for sale at a fixed price.

Although the listing 815 includes an offer to sell associations of an area of media with complimentary data that may be fixed regardless of a user that clicks on the area, additional properties may be used to further define an association. The additional properties may be based on information about users that click on the area. For example, geographic locations may be associated with an area of video and separately offered for sale (e.g., such that different retailers may be associated with a same area of video, but, different geographic regions). In some implementations, behaviors or interests may be offered for sale. For example, as a series of interactions of a user may be monitored by a server that serves ad content, patterns of behavior may be offered for sale and associated with ad content. As another example, interest in clothing articles in a video may be offered for sale (e.g., an option for selecting all clothing), such that areas of video which have associated descriptions that include words relating to clothing (e.g., sweater, pants, jeans, and the like) may be associated with ad content. To determine properties of a user, such as geographic location, or track patterns of behavior of a user, an internet protocol address of a user or other identifying information may be used (e.g., if a user has a handle for use with a media player, the handle may be used to track a user; e.g., an internet protocol address of a user may be used to determine a geographic location of a user).

When a sale is complete, a user may be able to associate one or more actions with the area of video or, for example, key words that have been purchased. For example, the user may associate a summary of a product with key words. Or, an area of video may be associated with a URL such that a user may cause a web browser to open to a retailer's web site. As another example, key words may be associated with a phone number to call. As another example, key words may be associated with a streaming audio feed to play in a streaming audio player and a web site to display in a web browser.

The user interface 905 of FIG. 9 is similar to the user interface 805 of FIG. 8. For example, the user interface 905 of FIG. 9 includes a listing 910 of associations for sale. However, the user interface 905 of FIG. 9 may filter out associations of areas of media not for sale. In addition, the user interface 905 may include more detailed sales information, such as information about a number of days left for an auction 915 of an association and a current bidding price 920 of an association.

In variations, additional or different data may be displayed in a listing of defined areas of a video. Also, a user may be allowed to define an area of video that is not listed. For example, a user may be able to send an electronic message characterizing a click. In response to that message, a new area of video may be offered for sale. Advantageously, areas of video that might not have been considered worth defining may be sold.

In some implementations, areas of video that have been clicked by users of a media player but have not been defined as being for sale may be identified. These areas may be found based on a lack of a definition of the area and they may then be defined and offered for sale.

Types of transactions, other than auctions or fixed-price sales may be supported. For example, a lease may be offered for an area of video, and those terms of sale may be displayed.

Data different to or in addition to a shopping URL may be associated with an area of media, such that an association that is offered for sale may include other types of data or information. For example, areas of video may be associated with a HyperText Markup Language (“HTML”) area that is displayed as a row item (such as the row items 350 of FIG. 3), such that an association of an area of media to an encapsulation of data is for sale, rather than simply a space for a shopping URL. For example, a licensee of an association may use HTML to add plug-in content, such as an audio file, to be associated with an area of video. The plug-in content may be triggered in response to a user click on the associated area of video, without causing a web browser to be displayed or a link to the content to be displayed. For example, in response to clicking on an area of video, an audio file may be played.

Instead of, or in addition to, offering for sale potential associations of an area of video with complementary data, associations of complementary data with key words that may match descriptions in media may be offered for sale and the key words may be associated with complementary data. For example, the key word “sweater” that matches a description of an area of one or more videos may be offered for sale. When purchased, an owner may be able to associate the key word with the URL of their sweater catalogue. Then, any area of video having an associated description with the key word “sweater” may be associated with the URL of the catalogue (e.g., dynamically, in response to a user clicking on an area of video, which may in turn cause a web browser to launch with the URL chosen by the user). In some implementations, any number or type of actions may be associated with an area of video.

In addition to, or instead of, key words, other properties may be used to define the sale of an association of media with complementary data. For example, an association of complementary data with a combination of key words, geographic area, and a specific video title may be offered for sale. For example, for a particular film, association of complementary data with all areas of video having a description with key words matching “car” may be offered for sale, and, a particular car manufacturer may purchase the association.

Sales of associations need not be exclusive. For example, multiple associations may be offered for a same set of key words. In that example, different associations may be indicated as being preferred such that, for example, clicks result in certain product summaries being listed in a higher order. For example, an airline may purchase a highly-preferred association with a key word “plane” for a film such that the first result sent to a user that clicks on areas of video having a description with the key word plane is complementary data chosen for association made by the airline (e.g., an airline's website).

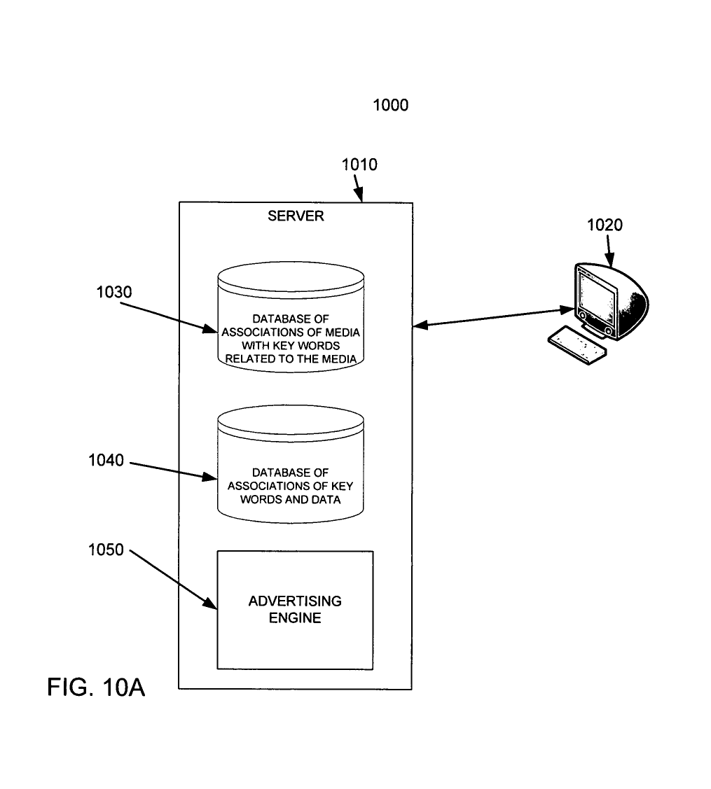

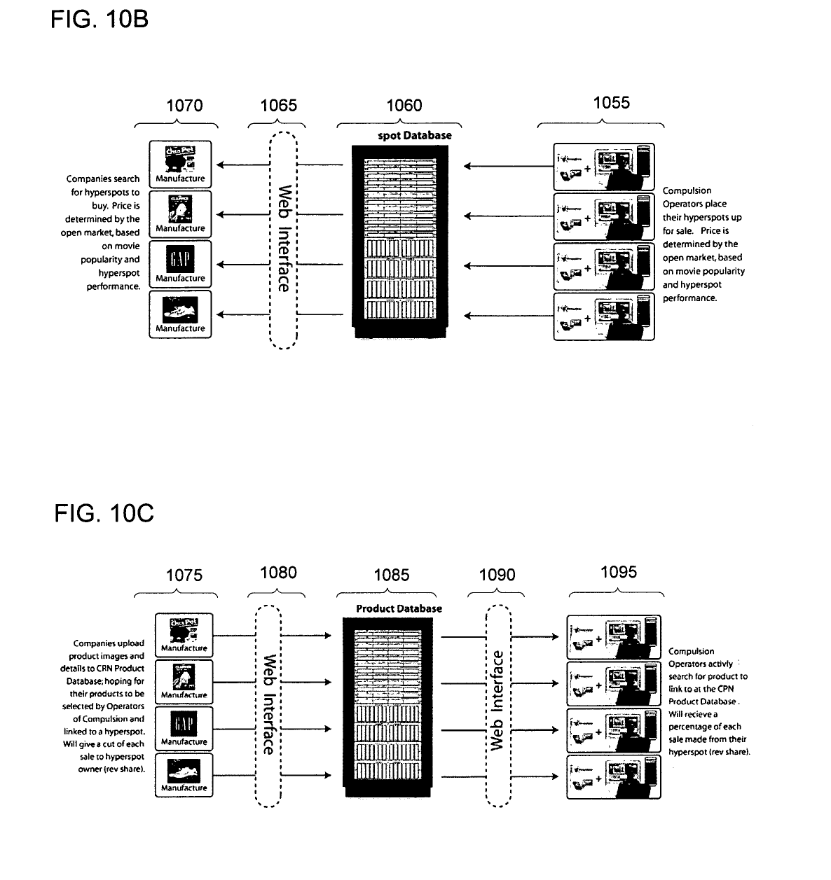

FIG. 10A is a diagram of a system 1000 to distribute resources related to media (e.g., dynamic distribution of resources). The system 1000 includes a server 1010 and a user computer 1020 that interacts with the server 1010. In general, the user computer 1020 may include a media player that provides data complementary to video in response to user interaction with the video, such as the media players described above. Requests for complementary data may be sent to the server 1010, which may satisfy the requests.

As an example of interaction between the user computer 1020 and the server 1010, the user computer 1020 may send a request for data complementary to media to the server 1010. For example, an application to application web services message that includes coordinates of a selected area of video, a playback time of the video, and a title of the video may be sent from the user computer 1020 to the server 1010. In response to the request, the server 1010 may perform searches to find data complementary to the media. Then, the server 1010 may respond with an application to application web services message to the user computer 1020, where the message includes the data complementary to the media. In response to receiving the message, an action may be performed at the user computer 1020. For example, the user computer 1020 may display a product summary that is associated with the area of media that was selected.

The server 1010 includes two databases 1030, 1040 and an advertising engine 1050 to satisfy requests for data complementary to a selected area of video (e.g., media). The first database 1030 includes associations of media with key words related to the media and the second database 1040 includes associations of key words and data (e.g., complementary data).

To satisfy requests, the server 1010 searches the first database 1030 to find key words associated with the area of video characterized by the requests. For example, an area of video including male slacks may be associated with the key words “male slacks.” Then, the key words may be used to search for complementary data associated with the key words at the second database 1040. The search for complementary data may be performed by the advertising engine 1050 or another component of the server 1010. The advertising engine may be used to organize, filter, or both search results by advertisers (e.g., sponsors). For example, if a number of results are associated with key words, only advertisers may be shown. As another example, an order of results may first include advertisers. As another example, advertisers may be prioritized according to a degree of sponsorship (e.g., depending on how much is spent by a sponsor).

Because key words are associated with a request for data complementary to an area of video, the search results may differ each time a search is performed. Advantageously, the link between an area of video and complementary data need not be a hard link (e.g., as opposed to a soft link that is dynamic). For example, updated information may be retrieved in search results. For example, search results including data from sponsors may differ based on a change of sponsors over time. As another example, a price of an item may change daily and that item may be associated with key words, such that the price data associated with key words may change but the association of the key words with the area of video need not change. This may be advantageous where key words are associated across videos. For example, the key words “red sweater” may be chosen for a larger clothing retailer across all videos, and, the individual links for each video need not be changed, rather, a single link to the association with the advertiser may change. As another example, a process of prioritizing search results may differ over time, and such a system may adapt for such a process. For example, a very supportive sponsor may be prioritized for a first thousand results of a day (for certain key words) and the sponsorship prioritization may change after the first thousand results.

In addition to using key words describing an area of media to form a search of the databases 1030, 1040, other information may be used. Examples may include information from a description of media that separate from descriptions of areas of video (e.g., a description of a movie from a database of movies available through a web site; e.g., a movie summary or movie genre), information derived from a user's address or handle (e.g., a geographic location derived from a user's internet protocol address or user demographic information derived from a user's profile), and a history of selections of a user. For example, a geographic location of a user derived from an internet protocol address of a user may be included in a search of the second database 1040 to find advertisers local to a user. For example, different advertisers may be associated with different geographic locations of a user or ads from a same advertiser may differ depending on different properties of a user. For example, an auto manufacturer might not sell some models of cars to the California market (e.g., some diesel engine cars might not be offered for sale in California due to emission standards), so the types of cars displayed in an ad may differ depending on a location of a user. As another example, information based on a history of a user may be used to generate additional criteria for a search (e.g., an internet protocol address of a user may be used to track properties of areas of media selected by a user and that information may be used to determine a pattern; e.g., for a series of clicks relating to clothing having color, size, and material selections of navy blue, large, and cotton, that history may be used to send an ad for a sweater matching the history).

As key words may be associated with areas of media, a report analyzing key words, areas of media, and other properties may be generated by the server 1010 using a log of requests or searches on the first database 1030, the second database 1040, or both. For example, a two-dimensional report may include rows for each key word combination, columns for media containing the key words, and cells containing an amount of hits for the media with those key words.

A multi-dimensional reporting tool may be used to analyze combinations of properties of requests or searches on the databases 1030, 1040. For example, a user may be able to query for a number of hits matching “sports jersey” for all media of a genre type “music video” that was accessed between March and September. Similarly, such a reporting tool may be used to determine interest areas related to frequently-clicked areas of a video. For example, if a movie includes a variety of areas of video that are associated with key words relating to different industries (e.g., clothing, cars, consumer electronics, and the like), a report may be made that organizes key words in order of most-frequently clicked across various areas of video. And, that information may be used to determine if advertising relating to a certain industry should be explored for the video. For example, a report may determine that areas of video having descriptions with key words such as “car,” “wheel,” and “engine” are frequently clicked. Based on those key words being associated with areas of video that are most-clicked, an advertising agent may seek car dealers to associate with the video.

Analysis with multi-dimensional reporting tools may facilitate pricing of advertisements related to key words and collection of advertising revenue. For example, if pricing of advertising relating to video content is based on popularity of key words, a report of key words of a video may help determine which key words are popular.

In addition to or instead of sending data complementary to selections of areas of media sent to users in response to user selections, data may be pushed to users without such stimuli. For example, an area of a user interface, such as the user interface 505 of FIG. 5, may include a folder for sponsored data. In that folder, data may be pushed to a user (e.g., every ten minutes). The data that is chosen for being pushed may, for example, be based on a history of user selections of media (e.g., based on key word descriptions from past selections of areas of media that are associated with a user) and agreements with advertisers who have associated data with key words or patterns of key words.

FIGS. 10B and 10C are diagrams of systems to facilitate sales of associations of media with data complementary to the media. In general, in FIG. 10B, potential associations of data with media are put up for sale by users 1055 at a spot database 1060, where “spot” or “hyperspot” may refer to areas of media that may be associated with complementary data. Through the web interface 1065, manufacturers 1070 or other users of the web interface 1065 may purchase the potential associations. After purchasing the potential associations, the owner may generate an association between area(s) of media with data chosen by the owner.

For example, a user may purchase a hyperspot that covers a green sweater worn by an actor through twenty eight seconds of video. Then, the user may associate that area of video with their sweater catalogue that is offered online at a URL by inputting a URL at a web interface on a page that allows the area of video to be associated with a user-inputted URL. Thereafter, when users click on the area of video, while playing back a copy of the video, a media player may cause a web browser to open to the URL chosen by the owner of the association between the area of video and the complementary data.

The web interface 1065 that offers the sale of potential associations of media with complementary data may be similar to the user interfaces of FIG. 8 or 9. Different terms of sale or combinations of terms of sale may be implemented. For example, auctioning, fixed price sale, and the like.

In contrast to FIG. 10B, in FIG. 10C, sales of associations of media with complementary data may be facilitated by offering complementary data for association with media rather than offering for sale an association of complementary data with media. For example, rather than offering for sale an association of an area of video with content, content that may be associated with media is made available to users for association with their media. For example, the manufacturers 1075 may make summaries of products available through a web interface 1080 in a product database 1085. Then, through the web interface 1090, users 1095 may select from the product summaries products they desire to associate with areas of video.

For example, one of the users 1095 may author a series of a hyperspots in a video, such as a hyperspot of an area of video that includes a sweater. Then, the user may use the web interface 1090 to browse through or search for a product having a description matching “sweater”. Then, the user may select the product for association with the area of video selected by the user. The association may be recorded at a database of associations for areas of media with content (e.g., actions to display content or perform other actions), such as the hyperspot database 210 of FIG. 2, such that users of a media player may view a copy of the video, select the area of video having the sweater, and cause a product summary of the sweater to be displayed.

In some implementations of FIG. 10C, actions need not be directly associated with areas of video. For example, key word descriptions may be associated with product summaries and those key word descriptions may be used to facilitate the sale of key word associations with a video. For example, areas of a video may be associated with the key word “sweater” and the product database 1085 may be browsed to find potential buyers of the association of the key word “sweater” with their products in the video.

In addition to, or instead of, storing product summaries, the product database may include other actions or content associated with a product. For example, the product database may include a link to a video to be displayed and the link to the video and terms for facilitating the sale of a hyperspot may be made available (e.g., a price, hit-based revenue calculation, or contact information). A user may find the link to the video and select it for association with a hyperspot. Then, the hyperspot may be associated with the link to video such that the linked video is to be displayed when the hyperspot is selected (i.e., when the area of video referred to be the hyperspot is selected a second video may be played).

Information to facilitate association of complementary data in the product database 1085 with media may vary. For example, the product database 1085 may simply include contact information of a person to negotiate sale of a hyperspot to link to a product. As another example, a product may offer a commission for associating the product with a hyperspot. For example, if a user clicks on a hyperspot which links to a product and the product is sold, a portion of the sale proceeds may be offered to the person who associated the area of video with the product.

The groups of users of the system of FIGS. 10B and 10C may be differentiated as being active and passive. For example, through the system of FIG. 10C, businesses and advertisers may passively sell products and content owners may actively search for product to link to. Revenue share may incentive participation in such a system. Businesses and advertisers may be viewed as being passive as they need not actively seek out opportunities to connect their products. As another example, through the system of FIG. 10B, businesses may need to actively seek advertising opportunities such that they are active participants, yet, media content creators need only set association with their media for sale. The incentive for participation in such a system is that businesses may pay to ensure their product is associated with popular content and content creators profit from selling associations to their content. In either system, the host of the web interface for facilitating sales may profit (e.g., through a percentage of a sale, a subscription fee, and the like).

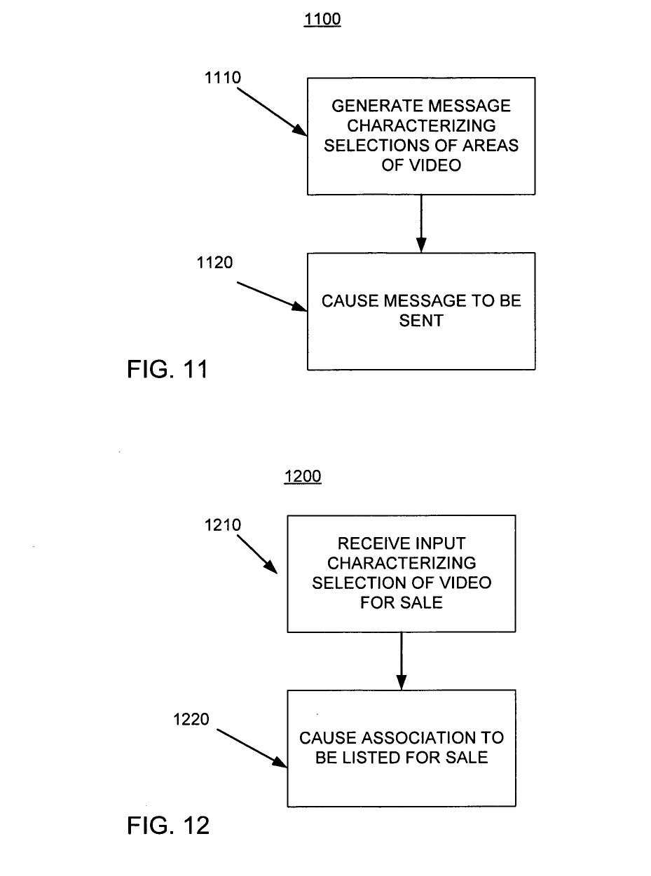

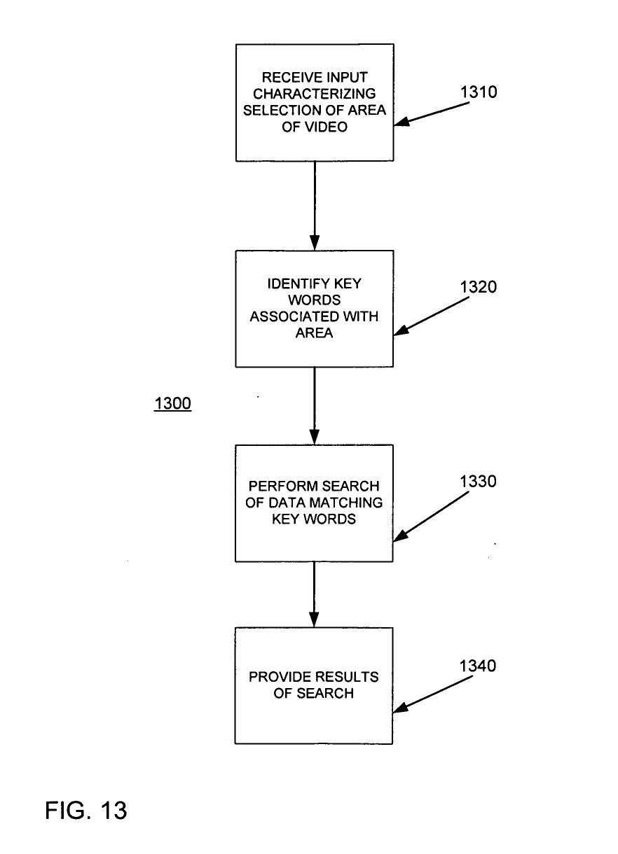

FIGS. 11-13 are flowcharts illustrating processes 1100, 1200, 1300 of causing a message characterizing selections of video to be sent, causing a selection of video to be listed for sale, and performing a search based on key words associated with a selection of video, respectively.

In the process 1100 of causing a message characterizing selections of video to be sent, a message characterizing one or more selections of areas of video is generated (1110). The message may be an electronic mail message (e.g., for domain name system messages or messages in accordance with the MIME standard) or other type of message (e.g., SMS, MMS, instant message, and the like).

The message may include resources related to the selections of video. The resources may cause actions to be performed at a recipient of the message. For example, the message may include a link, such as a URL, to data characterizing the selections. For example, where a selection is a product, a link to a product summary on a web site may be sent. The link may include data complementary to the selections. Encapsulations of data complementary to selections may be included in a message. For example, a picture corresponding to a product and a text description of a product may be encapsulated as an attachment and represent the complementary data. The data in the message may cause a media player to open and display the complementary data (e.g., by parsing the message or retrieving information from a web site). The message may further include a link to the video such that the video may be displayed. For example, the message may include information for finding a video and data characterizing data complementary to the video such that the complementary data may be displayed in concert with the video. As another example, resources in the message could prompt the recipient for information (e.g., a dialogue box with preference options may be displayed) and information related to a user selection may be displayed (e.g., for a message related to a selection of a sweater, a series of pull-down menus for sizes, style, colors, similarity (e.g., same one in video, similar, or any sweater) may be displayed at a recipient's computer. As another example, a message may include a collapsible tree-structured organization of click information (e.g., a list of information related to selections of areas of video made by the sender of the message, with long descriptions that may be collapsed to short descriptions; e.g., information related to selections by the sender may be organized in folders and the message may include a collapsible organization of summaries of information organized similar to the folders).

A message may be caused to be sent (1120). For example, a message that includes a link to data complementary to a selection of an area of video may be caused to be sent by setting up an electronic mail for sending by an electronic mail program. As another example, a message for an instant messaging environment may be sent to a user.

In the process 1200 of causing a selection of video to be listed for sale, input characterizing a selection of an area of video for sale may be received (1210). For example, a user may view a video using a media player and select areas of the video. The selections may be stored as data identifying areas of video and that data may be received. The data characterizing selections may be stored separately from the video, such that the video need not be copied to transmit data characterizing the selections. The data may include, as an example, a definition of a shape over playback time.

An association of a selection of an area of video may be caused to be listed as for sale (1220). For example, in response to receiving a selection of an area of video and a request to offer the video for sale, a web site may generate a listing of the video as being for sale (e.g., up for auction).

In the process 1300 of performing a search based on key words associated with a selection of video, data characterizing a selection of an area of video is received (1310). For example, the data may include x, y coordinates and a playback time.

Key words associated with an area of a video may be identified (1320). For example, a database may store associations of areas of video with key words. For example, an area of video that includes a billboard of a movie theatre may be associated with the key words “movie theatre listings” and the key words may be identified in response to a search of the database based on data characterizing a user selection of that area of video.

A search of data matching key words may be performed (1330) and the search results may be provided to a user (1340). For example, a database may include data that can be searched with by key words. As an example, an internet search engine may perform a search based on key words associated with a selection of an area of video. The search may be performed by, or assisted by, an advertising engine that organizes results according to sponsorship. For example, sponsors may pay more to be ranked higher in search results. The search results may be displayed in a media player that generates requests to search for data complementary to areas of video (e.g., the media players described above), or the results may be displayed in another tool (e.g., in a web browser).

Although the processes of FIGS. 11-13 include a certain number and type of sub-processes, variations may include additional, different, or fewer sub-processes.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server arises by virtue of computer programs running on the respective computers and having a client-server relationship to each other.

The subject matter described herein has been described in terms of particular embodiments, but other embodiments can be implemented and are within the scope of the following claims. For example, operations can differ and still achieve desirable results. In certain implementations, multitasking and parallel processing may be preferable. Other embodiments are within the scope of the following claims

What is claimed is:

1. A method comprising:
generating a message characterizing a plurality of selections of areas of video, the selections of the areas of video received at a media player capturing user interaction with the video and displaying resources related to the selections in response to the user interaction; and
causing the message to be sent to a recipient to enable an action related to the selections to be performed.

2. The method of claim 1, wherein the generating comprises arranging the selections in a plurality of groups of selections.

3. The method of claim 2, further comprising hierarchically arranging the groups of the selections.

4. The method of claim 1, wherein the action related to the selections is execution of a program separate from a tool to receive the message, and the method further comprises:
receiving the message at the tool of the recipient, and
causing the program to be executed.

5. The method of claim 1, further comprising:
receiving the message at an electronic mailing address associated with the recipient; and
causing a media player associated with the recipient to display a resource associated with a selection of an area, the display of the resource being the action related to the selections.

6. The method of claim 5, wherein the resources associated with the selections of areas comprises summaries of information about products and links to one or more merchants offering the products for sale.

7. The method of claim 1, further comprising:
receiving the message by a recipient; and
causing a media player associated with the recipient to generate bookmarks associated with the selections of the areas.

8. The method of claim 1, wherein the generating comprises generating a message comprising a reference to the video.

9. The method of claim 1, wherein the media player displays the video in a visual display and the media player includes a user interface to receive user interaction above the visual display of the video, the user interaction characterizing the selections of the areas of the video and the user interaction resulting in the selections being sent to a server to find the resources associated with the selections, and the server responding with the resources associated with the selections, the resources associated with the video and to be displayed by the media player.

10. The method of claim 9, wherein the media player separates the visual display and the user interface into two layers with the visual display beneath the user interface such that a video format need not be modified for the media player to:
generate the selections of the video based on the user interaction,
request the resources related to the selections of the video, and
to display the resources related to the selections.

11. A method comprising:
receiving input characterizing an identification of an area of a video to be offered for sale, the area to be associated with a resource to be presented in response to user interaction with the area of the video in a media player, the media player capturing the user interaction with the video and presenting resources related to the video in response to the user interaction to provide an interactive experience with the video and the resource being selected from a range of resources associated with the video based on the user interaction; and
causing to be offered for sale an association of the area of the video with a resource selected by the buyer.

12. The method of claim 11, wherein the receiving comprises:
receiving the input characterizing the identification via a request from a web browser.

13. The method of claim 11, wherein the causing comprises:
listing the area of video as for sale as part of an auction on a web site.

14. The method of claim 11 further comprising:
identifying the area of video to be offered for sale based on user-clicks on the area of the video and a lack of an association of the area of the video with a resource to be presented in response to interaction with the area of the video.

15. A method comprising:
receiving input characterizing a selection of an area of a video at a media player, the media player to capture user interaction with the video and to cause a resource related to the selection to be presented in response to the user interaction;
identifying one or more key words associated with the area of the video;
performing a search by an advertising engine for resources matching search criteria derived from the key words, the search being performed in response the identifying the key words; and
providing results of the search to a user.

16. The method of claim 15 further comprising:
receiving input characterizing:
a second selection of a second area of the video, and
the key words; and
associating the second area of the video with the key words;
wherein the area of the video is within the second area of the video.

17. The method of claim 15 further comprising:
receiving second input characterizing the selection of the area of the video;
identifying the key words associated with the area of the video at a second time;
performing a second search in response the identifying the key words at a second time, criteria of the second search comprising the key words; and
providing results of the second search to a user, the results of the second search differing from the results of the search.

18. The method of claim 15 further comprising:
identifying second key words associated with the key words;
performing a second search in response to the identifying the second key words, criteria of the second search comprising the second key words; and
providing results of the second search as recommendations to the user.

19. The method of claim 15 further comprising:
the advertising engine prioritizing results of the search based on a predetermined order of priority for advertisements, if the results include advertisements being prioritized.
